(19) United States
(12) Patent Application Publication
(10) Pub. No.: US 2016/0097023 A1
(43) Pub. Date: Apr. 7, 2016

(54) Capillary Whisky Sticks

(71) Applicant: Tony D. Peniche, Portland, OR (US)

(72) Inventor: Tony D. Peniche, Portland, OR (US)

(21) Appl. No.: 14/873,128

(22) Filed: Oct. 1, 2015

Related U.S. Application Data
(63) Continuation-in-part of application No. 29/506,315, filed on Oct. 14, 2014, now Pat. No. D749292.
Application No. 29/506,315 is a continuation-in-part of application No. 29/506,317, filed on Oct. 14, 2014, now Pat. No. D744717.
(60) Provisional application No. 62/058,272, filed on Oct. 1, 2014.
(60) Provisional application No. 62/058,268, filed on Oct. 1, 2014.
(60) Provisional application No. 62/058,260, filed on Oct. 1, 2014.
(60) Provisional application No. 62/058,264, filed on Oct. 1, 2014.

(51) Int. Cl. C12G 3/07

(52) U.S. Cl. CPC C12G 3/065

(57) ABSTRACT

A whisky bottle has a volume of liquid whisky and contains at least one piece of wood made primarily of oak that may otherwise be used to continue aging whiskey and other spirits post barreling inside of the bottle, where the at least one piece of wood has a total surface area thereof that is selected based upon the volume of liquid.

### BACKGROUND

The present invention relates to distilled spirits, alcoholic and non alcoholic beverages and other liquids which are stored in barrels to improve or enhance their flavor, quality and value.

While the invention applies to and is intended to be used to enhance and accelerate the traditional aging process in a range of spirits, beverages and liquids, we illustrate how the invention works specifically with whisky (or whiskey) spirits. Whiskey is the most common spirit consumed that is barrel aged to enhance and create its flavor. The process and reason for barrel aging whisky is very similar to other spirits, beverages and liquids. Therefore the process for aging whisky most clearly outlines the general benefits of barrel aging a liquid or spirit and thus how the invention works across all intended applications of aging.

Whisky (or whiskey) or whisky-like is a distilled alcoholic beverage made from fermented grain mash. Different grains are used for different varieties, including for example, barley, malted barley, rye, malted rye, wheat, and corn. Often the whiskey is aged in wooden casks, generally made of charred white oak. The typical unifying characteristics of different classes and types are the fermentation of grains, distillation, and aging in wooden barrels.

The whisky or whisky-like products often differ in their base product, alcoholic content, and quality.

Malt whisky is made primarily from malted barley. Single malt whisky is made from a single distillery made from a mash that uses only one particular malted grain. Often the single malt whisky is made from whisky from many casks and different years, so that the blender can achieve a taste recognizable as typical of the distillery.

Blended malt whisky is a mixture of a single malt whisky from different distilleries. Often the blended malt whisky can vary in taste by the blender selecting which whisky to mix together and the amounts thereof.

Blended whiskies are made from a mixture of different types of whisky. A blend may contain whisky from many distilleries so that the blender can produce a flavor consistent with the general desire, although can vary based upon the blender.

Cask strength, also generally known as barrel proof, whiskies are bottled from the cask undiluted or only lightly diluted. Generally, these are considered a higher quality whisky, and can vary based upon the blender

Single cask, also generally known as single barrel, whiskies are bottled from an individual cask (or barrel). The taste of such whiskies may vary substantially from cask to cask, even when done by the same blender using a consistent technique.

Whiskies do not age within the bottle, but rather within the cask, so the age of a whisky is the time between distillation and bottling. This reflects how much the cask has interacted with the whisky, changing its chemical makeup and taste. Whiskies that have been bottled for many years may have a rarity value, but are not older and not necessarily better than a more recent whisky that matured in wood for a similar time.

The flavoring of whisky is partially determined by the presence of congeners and fusel oils. Fusel oils are higher alcohols than ethanol and are mildly toxic, and have a strong, disagreeable smell and taste. An excess of fusel oils in whisky is considered a defect. A variety of methods are employed in the distillation process to remove unwanted fusel oils. Also, whisky that has been aged in oak barrels absorbs substances from the wood. One of these is cis-3-methyl-4-octanolide, known as whisky lactone, a compound with a strong coconut aroma. The flavoring process of whisky is thus highly dependent on the time and the techniques used by the blender.

Unfortunately, in addition to the variations of the blender, the taste tends to vary significant especially based upon the length of time the whiskey is in the barrel, type of wood the barrel is constructed of and how the barrel was prepared including if it had previously contained another fluid such as wine or another distilled spirit, if the wood is new or fresh will all have a substantial impact of the flavor and quality and value of the whiskey.

### BRIEF DESCRIPTION OF THE SEVERAL VIEWS OF THE DRAWINGS

FIG. 1 illustrates one embodiment of a capillary whisky stick.

FIG. 2 illustrates another embodiment of a capillary whisky stick.

### DETAILED DESCRIPTION OF PREFERRED EMBODIMENT

A whisky barrel is made out of wood, typically in a generally cylindrical shape. The whisky ages in the barrel over a number of years, such as 3 years, 5 years, 10 years, and 20 years. As a general matter, the longer the whisky ages in the barrel the better the whisky becomes. However, whisky that has aged a large number of years tends to be substantially more expensive, contains fewer toxins than whisky that has aged a limited number of years. After the whisky has sufficiently aged in the barrel, the distiller will decide to blend, re-barrel or bottle the spirit in bottles for distribution and sale to customers.

After consideration of the aging process of whisky it was determined that the surface area of the barrel relative to the volume enclosed within the barrel is a contributing factor to the aging process of the whisky. In addition, having a greater surface area relative to the volume tends to decrease the time required for adequate aging for sufficiently good flavor and color. For example, a whisky barrel may have a capacity of 31 gallons, 59 gallons, or 79 gallons. The surface area of the barrel is generally, the surface area of the bases (2*π*radius²) plus the surface area of the lateral sides (diameter*π*height). For example, a 26 gallon barrel may have a surface area of 2,000 square inches, a surface to volume ratio of ˜80 (square inches/volume in gallons). For example, a 59 gallon barrel may have a surface area of 6,500 square inches, surface to volume ratio of ˜110 (square inches/volume in gallons). By way of example, after the whisky is placed in the bottle, the aging process stops, and the bottle is sold to the consumer. It was determined that the aging process may be continued, at least to some extent, by locating a portion of wood from either a used whisky barrel or new wood cured in the same fashion as the inside of a whisky barrel as described herin can be placed in the bottle along with the whisky. The portion of the new wood or used whisky barrel may be located in the bottle during bottling or subsequently by the purchaser of the bottle. In this manner, the whisky in the bottle will continue to age. This additional aging process tends to improve the quality of the whisky within the bottle over time thus continuing to enhance the flavor, and value of the bottle.

A used whisky barrel, after the whisky has been transferred to bottles, tends to still have chemicals therein that may be used to further age whisky. A used whisky barrel may be cut into a set of smaller sticks. The sticks resulting from the cutting of the barrel are preferably have a diameter less than 0.75 inch at any particular location so that the stick may be located in a standard bottle. In addition, the sticks are preferably less than 12 inches in length so that they may fit within a whisky bottle. For example, the whisky bottle is preferably suitable to hold 500 ml to 2000 ml of whisky while being substantially full. For example, a whisky bottle may have a surface area on the order of 80 square inches, and a surface to volume ratio of generally 2, for a 750 ml bottle (i.e. ˜45 in³, ˜0.1649 gallons). The surface to volume ratio of the cut whisky barrel stick is preferably selected to be on the order of the same surface to volume ratio as that of a whisky barrel. For example, the desired ratio may be 80 for a barrel having a volume of 26 gallons. In that case, the surface area of the stick for a whisky bottle may be generally ˜13 inches square (e.g., 0.1649 gallons*80 ratio). In that case, the surface area of the stick for a whisky bottle may be generally ˜18 inches square (e.g., 0.1649 gallons*110 ratio). Preferably, the surface area of the stick or sticks located in the bottle is within 75% (more preferably 50%, and more preferably 25%) of such a ratio of the surface area to the volume. A desirable range may be generally from 5 square inches to 25 square inches. More preferably, a desirable range may be generally from 10 to 20 square inches. More preferably, a desirable range may be generally from 13 to 17 square inches. Further, a plurality of sticks may be used within a single whiskey bottle to achieve such a desirable range.

The whisky bottle is selected that the drinker desires to age more, and thus improve its color and taste. The top of the whisky bottle is opened, and the selected cut barrel stick(s) are inserted into the whisky bottle, preferably with a suitable total surface area. The whisky bottle is then sealed and the whisky bottle is aged with the cut whisky barrel contained therein to improve its color and taste.

Another technique to achieve a deeper more complex spirit is to further age the whiskey in a barrel that was previously used to age wine. Such wine barrels may include, for example, a port or sauterne. In this manner, after the barrels used to age wine are emptied, some of the wine's essence remains in the wood, When those barrels are refilled with a spirit, the spirit chases those vinous characters out of the wood, adding subtle favors and colors to the spirit in the barrel. The resulting spirit from the wine barrel is then bottled.

In another embodiment, a used wine barrel, after the whisky has been transferred to bottles from the whiskey infused wine barrel, tends to still have chemicals therein that may be used to further age whisky. In another embodiment, a used wine barrel, where whisky has not been aged in the wine barrel, tends to still have chemicals therein that may be used to further age whisky. Accordingly, the wine barrel may be cut into a set of smaller sticks.

The sticks resulting from the cutting of the barrel preferably have a diameter less than 1 inch at any particular location so that the stick(s) may be located in a standard bottle. The sticks resulting from the cutting of the barrel preferably have a diameter greater than 0.1 inch (or more preferably 0.25 inch, or more preferably 0.50 inch) at any particular location so that the stick(s) may be readily removed from a standard bottle. Preferably, the length of the stick(s) is greater than 2.5 inches, Preferably, the length of the sticks is less than 9 inches. The length of the sticks are preferably the same, and are preferably within one of the set of ranges defined by being greater than and less than, as described above. The resulting sick(s), sized as previously described with respect to a whiskey and/or wine barrel, may be located in the whiskey bottle to further age the whiskey.

The aging of whisky is preferably done using oak, and more preferably using American white oak (e.g., quercus alba), European oak (e.g., quercus robur), and Japanese oak (e.g., quercus mongolica). The naturally occurring oils, generally referred to as vanillins, are drawn out of the wood by the spirit during maturation and add to the whisky's flavor profile. While aged wood from whisky barrels provides an enhancement to the flavors of whisky, it was been determined that un-aged wood that may be otherwise used to make whisky barrels likewise provides an enhancement to the flavors of whisky.

Bourbon whisky, which is a type of American whiskey, is a barrel aged distilled spirit made primarily from corn. Preferably the bourbon has a grain mixture that includes at least 51% corn which is aged in new charred oak barrels. The bourbon is preferably distilled to no more than 160 proof (i.e., 80% alcohol by volume) while entering into the barrel for aging at no more than 125 proof, and bottled at 80 proof or more. While aged wood from bourbon whisky barrels provides an enhancement to the flavors of whisky, and especially bourbon whisky, it was been determined that un-aged wood that may be used to make bourbon whisky barrels likewise provides an enhancement to the flavors of whisky, and especially bourbon whisky.

Scotch whisky, generally referred to as scotch, is a malt whisky or grain whisky typically aged in oak barrels. While aged wood from scotch whisky barrels provides an enhancement to the flavors of whisky, and especially scotch whisky, it was been determined that un-aged wood that may be used to make scotch whisky barrels likewise provides an enhancement to the flavors of whisky, and especially scotch whisky.

The selected woods and the size thereof, as previously described, that are suitable to be inserted within a standard sized bottle, as previously described, enhance the flavor profile of the spirits. While such selected woods enhance the flavor profile of the spirits it was determined that the flavor profile may be even further enhanced by pre-processing the selected woods prior to being inserted within a standard sized bottle. The enhanced pre-processed selected woods may be achieved by heating up the wood sticks, namely wood that didn't originate with whisky barrels (or other barrels), for a limited duration of time at a limited temperature.

The heat provided to the sticks is preferably between 150 degrees F. and 600 degrees F. for a duration between 30 minutes and 72 hours. Preferably, the sticks are heated at approximately 400 degrees for approximately 4 hours. Preferably, the sticks are baked (e.g., heated) between 200 and 450 degrees from 30 minutes to 6 hours. In addition, to ensure a more even heating of all the surfaces of the sticks, which results in an improved flavor profile, it is preferable to sticks are their final size prior to heating the sticks. In this manner, each of the surfaces of the sticks are more evenly heated.

The selected woods and the size thereof, as previously described, that are suitable to be inserted within a standard sized bottle, as previously described, that is heated for a limited duration at a limited temperature enhance the flavor profile of the spirits. While such selected woods that are heated enhance the flavor profile of the spirits it was determined that the flavor profile may be even further enhanced by further-processing the selected woods prior to being inserted within a standard sized bottle. The enhanced further-processed selected woods may be achieved by charring the exterior surface of a majority of the surface of the wood sticks, namely wood that didn't originate with whisky barrels (or other barrels). For example, a foil may substantially enclose one or more sticks while heating at a temperature between 600 and 1400 degrees F. for up to generally 10 minutes, or using a direct high intensity flame for up to generally 5 minutes.

While the use of the sticks tends to result in a significant improvement in the whisky over time, it can take a significant amount of time to achieve a sufficient improvement in the taste depending on the particular preferences of the drinker. After further consideration, it was determined that a significant amount of capillary action is involved for the whisky to effectively absorb the flavors from the wood. With long sticks that are relatively thin, the capillaries of the wood tend to be very long many of which extending from one end of the stick to the other end of the stick. With the sticks placed within the whiskey bottle substantially submerged in whisky, it takes a significant amount of time for the whisky to soak in one end of the stick and through capillary action be discharged out of the other end of the stick. It was determined that by decreasing the overall length of the capillary action, a greater amount of whisky can effectively travel through the wood absorb the flavor from the wood more rapidly. but it is undesirable to decrease the overall length of the sticks. In addition, by having the entire length of the capillary action that occurs being submerged within the whisky tends to further increase the effective capillary action.

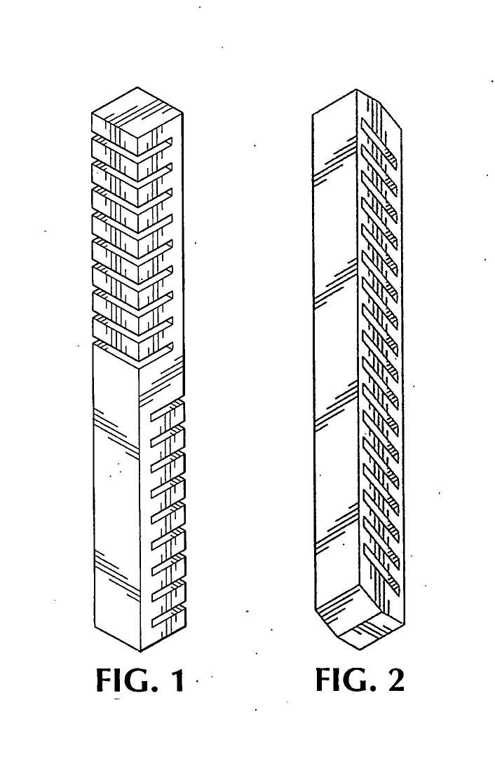

Reciting to FIGS. 1 and 2, it is desirable to include “notches” in one or more locations along the length of the stick. The notches break up the capillary action along the length of the stick (in a direction aligned with the grain of the wood). Preferably there are a plurality of notches in the wood. Preferably, there are a sufficient number of notches of a sufficient size that a majority of volume of the stick has end-to-end capillary action that is decreased by a factor of at least a quarter in the length of the capillary action. For example, this may be achieved with a single notch that is positioned at a location 25% of the length of the stick in from the end of the stick, that has a cross sectional area greater than half of the cross sectional area of the stick. More preferably, there are a sufficient number of notches of a sufficient size that a majority of volume of the stick has end-to-end capillary action that is decreased by a factor of at least half in the length of the capillary action. More preferably, there are a sufficient number of notches of a sufficient size that a majority of volume of the stick has end-to-end capillary action that is decreased by a factor of at least two-thirds in the length of the capillary action.

Another structure includes a plurality of “holes” in one or more locations along the length of the stick. The “holes” may extend through the entire width of the stick or otherwise only a portion thereof. The holes break up the capillary action along the length of the stick (in a direction aligned with the grain of the wood). Preferably there are a plurality of holes in the wood. Preferably, there are a sufficient number of holes of a sufficient size that a majority of volume of the stick has end-to-end capillary action that is decreased by a factor of at least a quarter in the length of the capillary action. For example, this may be achieved with a single hole that is positioned at a location 25% of the length of the stick in from the end of the stick, that has a cross sectional area greater than half of the cross sectional area of the stick. More preferably, there are a sufficient number of holes of a sufficient size that a majority of volume of the stick has end-to-end capillary action that is decreased by a factor of at least half in the length of the capillary action. More preferably, there are a sufficient number of holes of a sufficient size that a majority of volume of the stick has end-to-end capillary action that is decreased by a factor of at least two-thirds in the length of the capillary action.

Preferably, the notches, holes, or otherwise deforming an otherwise preferably smooth surface in the exterior surface of the stick are of each of an overall concave shape. Preferably, the addition of the notches, holes, or otherwise increases the exposed exterior surface area of the stick by at least by at least 20%, and more preferably by greater than 30%.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A bottle containing any spirit, liquid, beverage or whisky that has been or could be aged utilizing the traditional barreling process and comprising:
(a) a bottle having a volume of liquid contained therein;
(b) at least one piece of wood made primarily of oak including at least one deformation in the exterior surface thereof of a sufficient size that a majority of the volume of said at least one piece of wood has end-to-end capillary action that is decreased by a factor of at least a quarter in the length of said capillary action, where said at least one piece of wood have a total surface area thereof, where said total surface area thereof is selected based upon said volume of liquid;
(c) said at least one piece of wood located within said whisky bottle.

2. The bottle of claim 1 wherein said bottle is suitable to hold 500 ml to 2000 ml of liquid while being substantially full.

5. The bottle of claim 1 wherein each of said at least one piece has a largest diameter no greater than 0.75 inch.

6. The bottle of claim 5 wherein each of said at least one piece has a smallest diameter no less than 0.1 inch.

7. The bottle of claim 1 wherein said capillary action is said decreased by a factor of at least half in the length of the capillary action.

8. The bottle of claim 1 wherein said capillary action is said decreased by a factor of at least two-thirds in the length of the capillary action.

9. The bottle of claim 1 wherein said deformation in the exterior surface thereof increases the exposed exterior surface of said stick without said deformations by at least 20%.

10. The bottle of claim 1 wherein said deformation in the exterior surface thereof increases the exposed exterior surface of said stick without said deformations by greater than 30%.

11. The bottle of claim 1 wherein said total surface area is between 5 inches square and 35 inches square.

12. A bottle containing any spirit, liquid, beverage or whisky that has been or could be aged utilizing the traditional barreling process and comprising:
a) a bottle having a volume of liquid contained therein;
b) at least one piece of wood made primarily of oak that may otherwise be used to replicate the traditional barrel aging process within the bottle to age a spirit, beverage, liquid or whisky, where said at least one piece of wood have a total surface area thereof, where said total surface area thereof is selected based upon said volume of liquid;
c) said at least one piece of wood located within said bottle.

13. The whisky bottle of claim 1 wherein said at least one piece is a single piece.

14. The whisky bottle of claim 1 wherein said at least one piece is a plurality of pieces.

15. The whisky bottle of claim 1 wherein said at least one piece is heated for a duration between 30 minutes and 7 hours at a temperature between 150 degrees F. and 600 degrees F.

16. The whisky bottle of claim 7 wherein said at least one piece that are said heated are in their final size prior to being heated.

17. The whisky bottle of claim 7 wherein said at least one piece are further charred.

18. A bottle containing any spirit, liquid, beverage or whisky that has been or could be aged utilizing the traditional barreling process and comprising:
a) a bottle having a volume of liquid contained therein;
b) at least one piece of wood made primarily of oak that may otherwise be used to continue the barrel aging process of whiskey, wine, and other spirits and liquids which traditional barrel aging is used to enhance the flavor and value of the liquid said at least one piece of wood for this use is to have a total surface area thereof, where said total surface area thereof is selected based upon said volume of liquid;
c) said at least one piece of wood located within said bottle or post traditional barrel storage non-wood container.

19. The bottle of claim 18 wherein the piece of wood substantially alters the chemical composition of the liquid, spirit or beverage within 48 hours in a manner greater then what is normally chemically measured over the course of greater than one year in a traditional barrel used for the purpose of enhancing its contents.
